(19) United States
(12) Patent Application Publication
(10) Pub. No.: US 2025/0146469 A1
(43) Pub. Date: May 8, 2025

(54) Apparatus and Method for Repurposed Wind Turbine Blades

(71) Applicant: Jordan Farnsworth Smith, Spanish Fork, UT (US)

(72) Inventor: Jordan Farnsworth Smith, Spanish Fork, UT (US)

(21) Appl. No.: 18/503,151

(22) Filed: Nov. 6, 2023

(51) Int. Cl. F03D 1/06; F03D 7/02

(52) U.S. Cl. CPC F03D 1/0675; F03D 7/0224

(57) ABSTRACT

Decommissioned wind turbine rotor blades are repurposed in alternative aerodynamic configurations with reduced or differentiated mechanical stress and cost-of-operation modalities. In one exemplary configuration, repurposed blades are affixed on a differentiated axial and gravitational orientation. In another exemplary configuration, the repurposed blades are longitudinally segmented. In yet another configuration, the blades are multiplied in a configuration designed for slower rotation. Additional alternative stress-differentiated and cost-of-operation configurations are disclosed herein. In a method of manufacture, repurposed wind turbine blades are provided in conjunction with blade configurations adapted to differentiated stress profiles.

### BACKGROUND

### Field of the Invention

The disclosure relates generally to the recapture of value of decommissioned wind turbine rotor blades. More specifically, to the repurposing of obsolete or fatigued fiber-reinforced polymer (“FRP”) blades.

### Background of the Disclosure

Production of usable energy from wind is a rapidly growing segment of world economies. Wind energy is often harvested by utility-scale wind turbines (i.e., wind turbines designed to supply greater than 100 kilowatts). Wind power is considered one of the cleanest, most environmentally friendly energy sources presently available, and wind turbines have gained increased attention in this regard. A modern wind turbine typically includes a tower, generator, gearbox, nacelle, and one or more rotating airfoils (“blades”). The rotor blades convert kinetic wind energy into rotational energy which is then used by a generator to produce electricity. A power converter typically regulates the flow of electrical power between the generator and a broader electric grid having a variety of electrical demands.

The airfoils in modern wind turbines often work in a similar manner as aircraft wings. In antiquity “windmills” have converted wind energy to rotational energy in a generally less efficient manner using drag-type aerodynamic surfaces we refer to herein as “sails”. Though less efficient, some wind-to-energy devices (“wind turbines”) still use sails. Sails can be inexpensive and durable. As used herein, the words “airfoil” and “sail” will be referred to generically as “aerodynamic surfaces” or “Blades.”

Utility-scale wind turbine design is a highly developed science focused on the efficient use of finite resources to maximize energy production. Much of modern design focuses on optimizing force derived from kinetic movement of air around blades. Within this development paradigm, optimized blades have grown longer and larger, and the towers upon which they sit have grown progressively taller.

For example, a typical commercial wind turbine installed in the United States from 1980-2010 has a blade 126′ in length weighing about 10 tons. The rotational speed of such a blade at the tip ranges from about 120-180 miles per hour, depending on wind velocity. They are situated on towers about 260′ in the air and reach to nearly 400′ in total height. Because of this massive scale, modern turbine blades are subject to constantly varying and severe mechanical forces. The average theoretical life span of such a blade is 20-25 years. The actual time to obsolescence is about 10-20 years.

Due to immense forces, these blades are constructed of lightweight, strong and flexible materials. The commonly selected material is FRP composite. The composite matrix of FRPs is usually a thermoset polymer, epoxy being the most common thermoset used. However, thermoplastics are increasingly explored as a more recyclable alternative. The reinforcing fiber is often fiberglass, but carbon fiber, aramid fiber or other fibers may be used. Sometimes the FRP superstructure is filled, supported, or supplemented with polymer foam, wood, metal, or other plastic materials. As the primary structure is FRP, incidental materials will not be discussed in further detail. As used herein, “fiber-reinforced polymer” refers to any gross blade structure wherein the primary supportive constituent is FRP.

The blades and tower together comprise up to about one-half of the installed cost of a horizontal axis wind turbine (“HAWT”) of the sort described.

A typical HAWT may have three blades oriented radially to a horizontal drive shaft, hub or combination thereof. The mechanical forces applied to FRP blades typically result in a serviceable life of 20 to 25 years. After that time, a blade's mechanical integrity may be called into question. A blade could also become damaged, or a production flaw revealed which would similarly obsolete that blade. New, more efficient blades sometimes become available to obsolete existing blades, even before their mechanical serviceability draws to a close.

Obsolete and mechanically compromised blades have typically ended up in landfills. The bulk, structural integrity, and environmental longevity of FRP blades is unrivaled among most waste products. Some have speculated that FRP blade components will outlast concentrated radioactive waste in terms of decomposition. Blade waste is projected to reach over 2 million tons in the United States and 43 million tons globally by the year 2050. This presents a serious disposal problem and contradicts public policy driving alternative energy solutions, such as renewable wind energy. There are a variety of non-landfill proposals for obsolete FRP blades. For example, recycling FRP materials has been described by means of accelerated chemical breakdown, thermal breakdown, and physical/mechanical breakdown. This typically begins with sawing the blades into more readily transportable pieces at a wind turbine facility. Each of these recycling patterns has substantial environmental and economic impact profiles.

FRP blades may also be repurposed in a structurally gross or a modified form. These uses include general structural supports like bridge components, cellular towers, utility poles and snow breaks; as well as segments such as fencing, playground equipment, architectural panels, shelters, crane mats and aesthetic sculptures. Repurposing presents challenges, as well. Modification of FRP blades is often more expensive than manufacturing objects from virgin materials. If the FRP blades are not modified on site, transportation costs are prohibitive. Transportation and storage of used blades and blade parts is unsightly and unnecessarily obstructs local and interstate traffic.

The scale and number of obsolete FRP blades far exceeds the resources available for these known recycling and repurposing methodologies.

### BRIEF DESCRIPTION OF THE INVENTION

The present disclosure provides descriptions of apparatus and methods for repurposing decommissioned wind turbine rotor blades in alternative structural configurations. These alternative configurations accept the nature of obsolescence causing decommissioning but recognize a blade's basic aerodynamic design. Most importantly, repurposing blades as differentiated aerodynamic surfaces obviates expensive and environmentally impactful, known recycling and repurposing alternatives.

These and other features, aspects and advantages of the present invention will become better understood with reference to the following description and appended claims. The accompanying drawings, which are part of this specification, illustrate, by way of example, embodiments of the disclosure and, together with the description, serve to explain principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, which are not necessarily drawn to scale, in which:

FIG. 1 is a perspective view of a conventional utility-scale HAWT.

FIG. 2 is a perspective view of a three-blade vertical axis wind turbine (“VAWT”).

FIG. 3 is a perspective view of a five blade HAWT having five repurposed longitudinal blade segments according to an embodiment of the invention.

FIG. 4 is a perspective view of a three-blade, segmented VAWT with three levels of support according to an embodiment of the invention.

FIG. 5 is a perspective view of a savonius-type VAWT according to an embodiment of the invention.

FIG. 6 describes a method of constructing a wind turbine in accordance with a preferred method of the invention.

### DETAILED DESCRIPTION OF THE INVENTION

Reference will now be made in detail to embodiments of the invention, one or more examples of which are illustrated in the drawings. Each example is provided by way of explanation, not limitation of the invention. It will be apparent to those skilled in the art that various modifications and variations can be made in the present invention without departing from the scope or spirit of the invention. For instance, features illustrated or described as part of one embodiment can be used with another embodiment to yield a still further embodiment. Repeat use of reference characters in this specification and drawings is intended to represent analogous features or elements. Therefore, it is intended that the present invention covers modifications and variations as come within the scope of the appended claims and their equivalents.

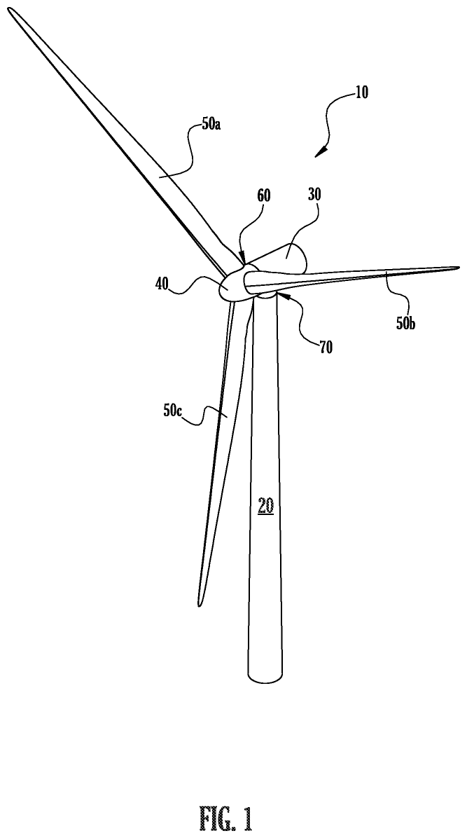

In the drawings, FIG. 1 illustrates a typical prior art wind turbine 10 from the 1980-2010 time period. It has a tower 20 affixed to a concrete foundation (not depicted) at ground level and a nacelle 30 affixed to the top of tower 20. Within the nacelle 30 are power transferring and converting apparatus (not depicted) for production of electric power. Ultimately hub 40 sits at the windward terminus of a horizontal axial drive (not depicted) primarily supported within nacelle 30. Blades 50a-50c are attached to hub 40 in an evenly spaced radial manner. Many of the typical physical dimensions of the HAWT 10 of FIG. 1 are set forth in the Background section and are adopted and incorporated herein by reference.

The wind turbine 10 of FIG. 1 is commonly referred to as a horizontal axis wind turbine or “HAWT”. Typically blades 50a-c are of uniform design, weight, length and composition. HAWT turbine designers have settled on three blades 50 as ideal, using cost/benefit analytics.

In this depiction of a typical HAWT 10, it can be readily observed that there are at least two axes of rotation. The primary observable axis of rotation 60 is between hub 40 and nacelle 30. The second observable axis of rotation “yaw” 70 is between tower 20 and nacelle 30. The primary axis of rotation 60 is necessary to transmit rotational energy used for electric power generation. However, yaw 70 is unique to directional wind turbines such as this typical HAWT 10. Yet additional and more complex axes of rotation occur between blades 50a-c and hub 40 called “pitch” which is a way to adjust the angle of attack of the airfoil blades 50a-c.

The composition and structure of blades 50a-c is more thoroughly discussed above in the Background section, as well as reasons they may become obsolete and decommissioned. That discussion is adopted and incorporated hereto, by this reference.

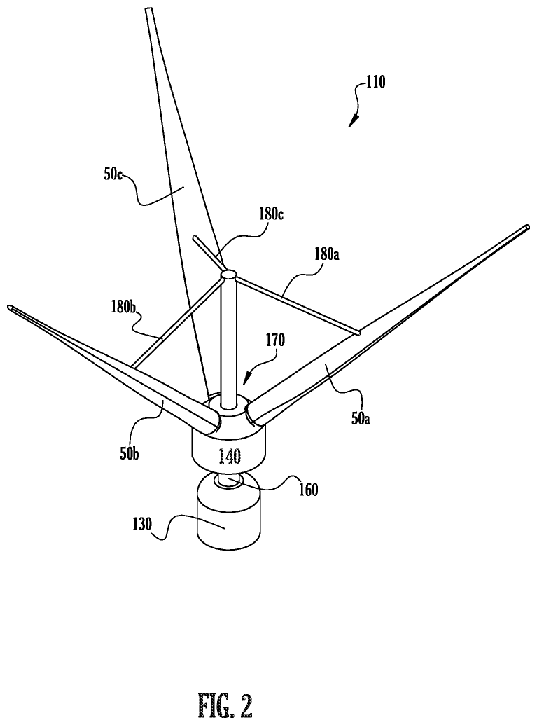

FIG. 2 illustrates a first preferred embodiment of an inventive VAWT 110 wherein blades 50a-c are attached to hub 140. Hub 140 is affixed to axle 160 and together they form a vertical axial drive 170. It will be appreciated that blades 50a-c, though obsolete, are structurally unchanged from blades 50a-c (FIG. 1).

Vertical axial drive 170 extends through and is supported by base 130. Vertical axial drive 170 further extends to engage and energize power generation means such as a generator (not depicted).

Whatever the reason for retiring blades 50a-c from HAWT (FIG. 1), they were subject to gravity stress loads which alternated on every rotation. As configured in VAWT (FIG. 2), there are no alternating gravity loads on blades 50a-c. This is an advantage in that it virtually eliminates one fatigue mode for blades 50a-c. Due to mitigation of alternating gravity loads in this embodiment, blades 50a-c are subject to an entirely different stress profile.

The primary advantage of VAWT 110 is that obsolete blades 50a-c can be safely reused, and the attendant costs of manufacture and transport of new blades avoided. An additional advantage is that Blades 50a-c are not deposited in a landfill or subject to recycling or reuse for a purpose contrary to their primary design.

Support of Blades 50a-c is further provided, in this embodiment, by stays 180a-c, attached to a mid-point on the long axis of the blades, on one end and to an extended portion of the axle 160, on the other. This is especially useful if blades 50a-c are structurally fatigued from prior use.

It is noted that blades 50a-c of this preferred embodiment are canted at about 45 degrees from vertical. This cant improves the aerodynamic efficiency of reused blades that have a profile twist. Though 45 degrees is considered ideal, a range from 30-70 degrees is acceptable, depending on the extent of the profile twist of the blade.

In this preferred embodiment the inventive VAWT 110, has a lower center of gravity than a typical HAWT (FIG. 1). First, blades 50a-c are oriented with their heaviest end continuously close to the ground. This blade arrangement may not require tall cranes for assembly. Also located near the ground are the axle 170 and hub 140 assemblies. This allows an attached generator and optionally gearbox (not depicted) to be at, near or below the ground rather than atop a tower as in the prior art depicted in FIG. 1. One advantage of having the generator near ground level is that heavier generators with ferrite magnets may be used. Ferrite magnets are generally heavier than neodymium magnets typically used to build light generators to be placed high in HAWT nacelles. Ferrite magnets are commonly less expensive, have better supply chains and have much less toxic environmental impact than neodymium magnets.

Compact hub 140 has a minimized size that reduces the complexity and cost of blade 50a-c pitch control systems (not depicted) that may be required to reach maximum efficiency due to putting pitch mechanics and lubrication in a centralized location.

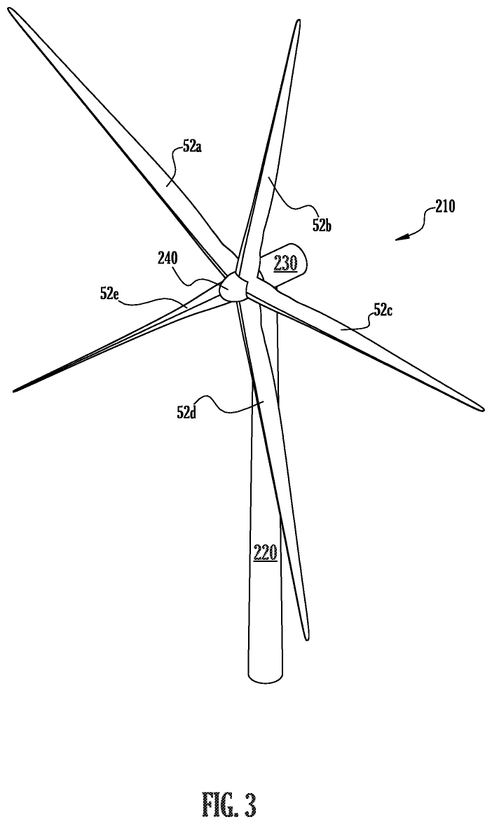

FIG. 3 illustrates a second preferred embodiment wherein HAWT 210 is specifically designed with altered airfoil blades (50a-c of FIGS. 1 and 2) such that stresses on blades 52a-e are reduced. Blades 52a-e are longitudinal segments taken from the distal end of obsolete blades 50a-c, FIG. 1. The highest mechanical loads introduced to obsolete blades are introduced proximal to an attachment point near hub 40 of FIG. 1. Therefore, in this preferred embodiment, that region of blades, 50 (FIG. 1) is simply removed and new attachment means (not depicted) applied, according to the art. The resulting airfoils 52a-e are lighter and stronger, having a renewed lifecycle.

Support 220 can either be reused in the same form and manner as tower 20 (FIG. 1) or it can be scaled down to a new less costly version thereof. Likewise with nacelle 230. Nacelle 230 and Support 220 combine to form a support base. Hub 240 differs from hub 40 (FIG. 1) in that it has additive structure to accommodate a greater number of blades 52. Hub 240 is attached to a horizontal axle (not depicted) and, together constitute an axial drive supported by the support base 220 & 230. In the preferred embodiment of FIG. 3, the number of blades 52a-e is increased from three (FIG. 1) to five.

It is generally accepted that increasing the number of turbine blades reduces rotational frequency (blade speed) without significantly reducing the overall rotational energy of the system. It is also generally accepted that a number of blades fewer than three and/or an even number of blades results in system imbalance and increases wear on all associated components. The primary reason to design turbines with fewer, larger blades (50a-c, FIG. 1) is to reduce the overall cost of the blades. Simply put, three new larger blades cost less to produce than four smaller blades with the same total surface area.

However, blades 52a-e have no manufacturing cost, as they are obsolete and discarded (FIG. 1). Transportation costs can be mitigated by either employing blades 52a-e, on the same site at which they were declared obsolete, or by cutting the segments at the site and transporting them by more conventional means to the new site. For example, blade segment lengths can be selected to correspond to fit on a semi-trailer (depending on the State, maximum length is between 53′ and 60′ without a special permit). In this preferred embodiment, five smaller blades 52a-e achieves the twin design goals of reducing rotational speed (less mechanical stress) and creating more system balance (less wear) without significantly increasing overall costs.

Blades 50a-e of HAWT 210 turn more slowly and are shorter than blades 50 (FIG. 1) from which they are derived. Therefore, they have slower tip speeds and produce less noise, making HAWT 210 more adaptable to distributed uses (dispersed at points of power consumption rather than a large wind farm) and human populated environments.

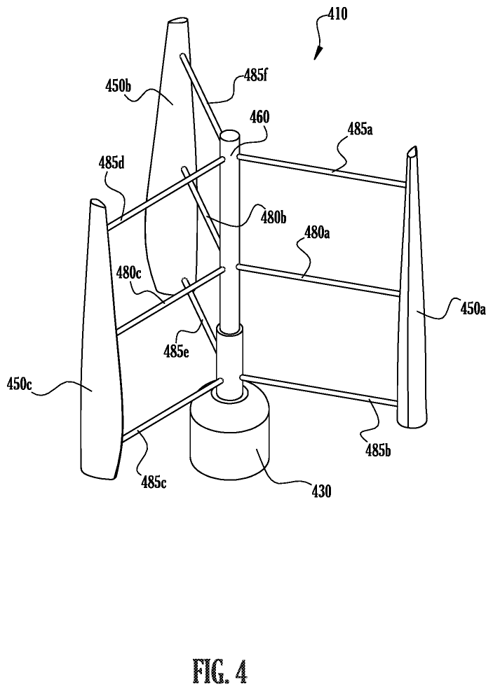

A preferred embodiment of the invention depicted in FIG. 4 is an H-type VAWT 410. In this embodiment, three repurposed airfoil blades 450a-c are situated with a long axis in a vertical orientation. Blades 450a-c are radially disposed about, affixed on, and supported by vertical axial drive 460. Axial drive 460 is in turn supported by base 430 and drives a ground-level generator (not depicted).

In this embodiment, blades 450a-c are longitudinal segments of original obsoleted blades comprising the segment of airfoil blades 50 of FIG. 1, that is aerodynamically optimal. That is to say that the structural portion of blades 50 adjacent to the hub 40 (FIG. 1) and the tips (which are designed for faster speed) have been removed. It will be appreciated that the entire length of obsolete blades 50 (FIG. 1), could be left intact without departing from the principles of the invention.

Blade segments 450a-c are primarily supported by stays 480a-c attached mid-way along the long axis of each blade 450. This “mid-way” attachment is not necessarily the linear mid-way point, but the natural balance point of the complex airfoil structure of the blade segment 450a-c. Stays 480a-c are also attached to axle 460 at a corresponding location. As the blade segments 450a-c are obsolete versions of blades 50a-c (FIG. 1) and potentially structurally fatigued, it may be desirable to add support such as braces 485a-f to the upper and lower regions of blades 450a-c. It will be appreciated that a combination of stays 480, braces 485 and other support means such as guy wires (not depicted) could be selected to support blades 450 upon axle 460.

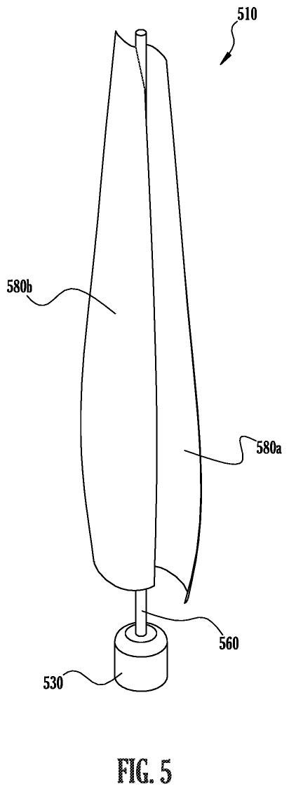

A preferred embodiment of the invention depicted in FIG. 5 is a savonius or drag-type VAWT 510. This embodiment consists of a vertical axle 560 and two sails 580a-b. The axle extends through a supporting base 530 and to a ground-level generator (not depicted). The sails 580a-b are crafted from two obsolete blades 50 (FIG. 1) by means of two longitudinal cuts on each obsolete blade, one on the leading edge of each blade 50, and one on each of the trailing edges. As in FIG. 4, the “sweet spot” can be selected by cutting off the hub and tip ends of blades 50 or the whole blade may be used. Any internal structure, crossmembers or filler may be removed. The depiction of sails 580a-b in FIG. 5 is from longitudinal midsections of blades 50 (FIG. 1). Two right-hand bisections of Blades 50 (FIG. 1) have been paired to formulate sails 580a-b. Sails 580a-b are attached to axle 560 at what was formerly the inside of the leading edge of blade 50.

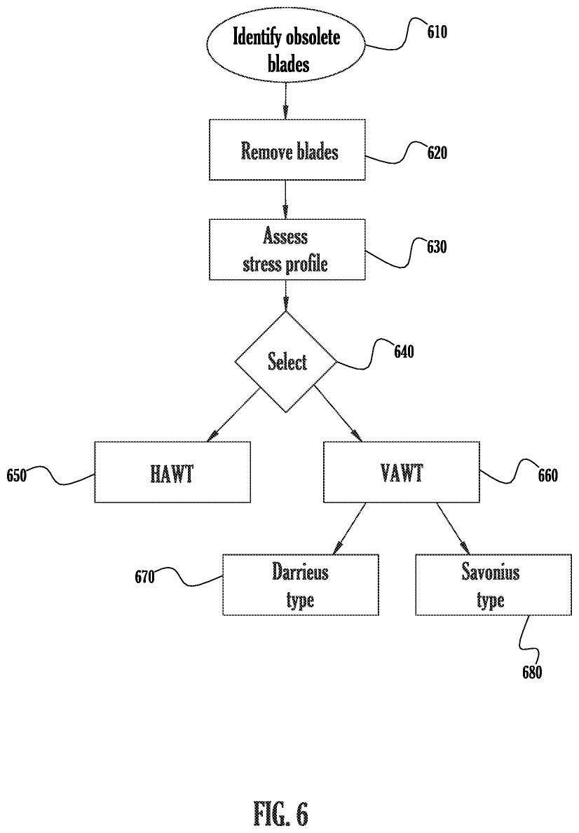

FIG. 6 describes a method of constructing a wind turbine in accordance with a preferred method of the invention. First 610, blades 50a-c (FIG. 1) are identified as obsolete in that either they have reached an unsafe stress modality or secondly, they might have become obsolete based on design. Either way the blades have reached a point in which they are slated for removal 620. Removal 620 is accomplished by known means such as a crane (not depicted). Next the blades are assessed for stress induced defects 630. This can be accomplished by analytical means such as ultrasound, visual, tactile or microscopy. An assessment of the initial design and historical use records of each blade 50 can be used, or some combination of assessment or analytics can be used to score the blade for utilization or disposal.

Next a HAWT 650 or VAWT 660 modality is selected 640 in accordance with the stress profile 630. For example, blade 50 might be determined to have reached an end-of-life-point at the attachment point but might have an aerodynamic mid-section that is structurally sound. In this instance, the mid-section would be harvested and used in a VAWT 660 as depicted in FIG. 4. If the blade 50 tip is found to be sound, it might be used in a HAWT 650 in accordance with the principles taught in FIG. 3. Perhaps the entire blade 50 is determined to be suitable for a darrieus-type VAWT 670 application as in FIG. 2. Additionally, longitudinally sound blades 50 might be dissected and used in a savonius-type VAWT 680.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A wind turbine comprising a support base, an axial drive rotatably attached to the base, and a plurality of elongate repurposed fiber-reinforced polymer rotor blades mounted to the drive.

2. The wind turbine of claim 1 wherein the blades are airfoils.

3. The wind turbine of claim 1 wherein the polymer is a thermoset.

4. The wind turbine of claim 3 wherein the polymer is an epoxy.

5. The wind turbine of claim 1 wherein the polymer is a thermoplastic.

6. The wind turbine of claim 1 wherein the plurality of repurposed blades have had a prior use in which they were subject to mechanical stresses sufficient to render them unusable in an intended prior application and wherein mechanical stresses of the present use differ from those of a prior use.

7. The wind turbine of claim 1 wherein the number of repurposed blades is greater than in a primary use design.

8. The wind turbine of claim 1 wherein the plurality of repurposed blades each have a long axis originally designed to be mounted to a horizontal-axis drive, and wherein each long axis is presently mounted to a vertical-axis drive.

9. The wind turbine of claim 1 wherein the plurality of repurposed blades comprise matching longitudinal segments of their original rendering, such that the segments are subject to reduced mechanical stress.

10. The wind turbine of claim 1 wherein the plurality of repurposed blades each have a first end attached to the drive and a second end supported by a stay.

11. The wind turbine of claim 10 wherein the repurposed blades are further supported by one or more stays midway between the first and second ends.

12. The wind turbine of claim 1 wherein at least two repurposed blades are bisected along a long axis and the halves mounted as longitudinally cupped sails on a vertical axial drive.

13. The wind turbine of claim 1 further comprising an electric generator wherein the support base, axial drive and generator are supported at ground level.

14. A method of constructing a wind turbine comprising the steps of: (a) providing a plurality of obsolete wind turbine blades mounted on one or more HAWTs having a configuration; (b) removing the obsolete wind turbine blades from the one or more HAWTs; (c) assessing a stress profile of the obsolete wind turbine blades; (d) selecting a wind turbine configuration alternative to the HAWTs of step (a), such that blade stress profile is different; and, (e) constructing the alternative wind turbine of step (d) using the plurality of obsolete wind turbine blades.

15. A method according to claim 14 wherein the wind turbine configuration of step (d) is a VAWT.

16. A method according to claim 14 further comprising step of: (c-1) segmenting the plurality of blades into useable matching longitudinal segments; and, wherein the plurality of blades of step (d) are matching segments.

17. A method according to claim 14 wherein the one or more HAWTs have three blades each, and the alternative wind turbine configuration has more than three blades.

18. A method according to claim 14 further comprising the step of bisecting the one or more blades along a long axis and wherein the wind turbine configuration of step (d) is savonius-type.

19. A wind turbine comprising a support base, a vertical axial drive rotatably attached to the base, a hub and a plurality of elongate repurposed fiber-reinforced polymer rotor blades mounted to the hub at an angle within a 30-70 degree range relative to the axial drive.

20. The wind turbine of claim 19 further comprising a blade pitch control system in the hub.
